(19) United States
(12) Patent Application Publication
(10) Pub. No.: US 2018/0329869 A1
(43) Pub. Date: Nov. 15, 2018

(54) DETERMINING APPEARANCES FOR ELEMENTS DISPLAYED ON USER INTERFACE

(71) Applicant: Microsoft Technology Licensing, LLC, Redmond, WA (US)

(72) Inventor: Darren K. Edge, Beijing (CN)

(21) Appl. No.: 15/772,955

(22) PCT Filed: Jan. 15, 2016
(86) PCT No.: PCT/CN2016/071004

§ 371 Date: May 2, 2018

(51) Int. Cl. G06F 17/21; G06F 17/24

(52) U.S. Cl. CPC G06F 17/211; G06F 17/24

(57) ABSTRACT

A device is provided for determining appearances for elements displayed on a user interface. In one implementation, GP the device includes a processing unit and a memory coupled to the processing unit and storing instructions for execution by the processing unit. The instructions, when executed by the processing unit, cause the device to: initialize a first appearance for at least one first element type, the first appearance specifying a first set of values of attributes for the at least one first element type, generate a first dimension of appearance schemes based on the first appearance and a first rule, each appearance scheme of the first dimension including at least one second element type associated with a second appearance, the second appearance specifying a second set of values of attributes for the at least one second element type, and determine the second appearance for the at least one second element N type from one of appearance schemes of the first dimension, to improve efficiency of operating the at least one second element type via the user interface. The device in accordance with the subject matter described herein improves efficiency of operating the at least one second element via the user interface. A method of determining appearances for elements displayed on a user interface and a computer program product are also provided.

### BACKGROUND

Conventionally, people are able to decide appearances associated with elements in a document or content to be displayed via a user interface. Existing tools may propose design schemes such as layout templates or color schemes in forms of templates which can be selected by users, but users are prone to selecting a color scheme by themselves so that the results appear unique and stylish. However, it is usually difficult for a user to set the appearance for a number of elements one by one, especially by directly manipulating graphical elements or entering attribute values. In addition, the process may be tedious and also require knowledge with regards to the color setting, color spaces and relevant methodologies. As a result, one may spend a lot of time on finding out an appropriate and satisfying color scheme for the document.

### SUMMARY

In accordance with implementations of the subject matter described herein, a solution for determining appearances for elements displayed on a user interface is proposed. Each of the elements has an element type. For a document including multiple elements (for example, shapes, lines, paragraphs, background, etc.), implementations of the present disclosure initialize a first appearance for at least one first element type, the first appearance specifying a first set of values of attributes for the at least one first element type, generate a first dimension of appearance schemes based on the first appearance and a first rule, and determine the second appearance for the at least one second element type from one of appearance schemes of the first dimension. Each appearance scheme of the first dimension includes at least one second element type associated with a second appearance. The second appearance specifies a second set of values of attributes for the at least one second element type. Efficiency of operating the at least one second element via the user interface is improved.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an environment where implementations of the subject matter described herein can be implemented;

FIG. 2 illustrates a flowchart of a method of determining appearances for elements displayed on a user interface in accordance with an example implementation;

FIG. 3 illustrates a flowchart of another method of determining appearances for elements displayed on a user interface in accordance with an example implementation;

FIG. 4 illustrates an example user interface for determining appearances for various elements used in a document in accordance with an example implementation;

FIG. 5 illustrates an example user interface of FIG. 4 after an updating step is invoked in accordance with an example implementation; and

FIG. 6 shows another example user interface for determining appearances for various elements used in a document in accordance with an example implementation.

Throughout the drawings, the same or similar reference symbols are used to indicate the same or similar elements.

### DETAILED DESCRIPTION

The subject matter described herein will now be discussed with reference to several example implementations. It is to be understood these implementations are discussed only for enabling those skilled persons in the art to better understand and thus implement the subject matter described herein, rather than suggesting any limitations on the scope of the subject matter.

As used herein, the term “includes” and its variants are to be read as opened terms that mean “includes, but is not limited to.” The term “or” is to be read as “and/or” unless the context clearly indicates otherwise. The term “based on” is to be read as “based at least in part on.” The term “one implementation” and “an implementation” are to be read as “at least one implementation.” The term “another implementation” is to be read as “at least one other implementation.” The terms “first,” “second,” “third” and the like may refer to different or same elements. Other definitions, explicit and implicit, can be included below.

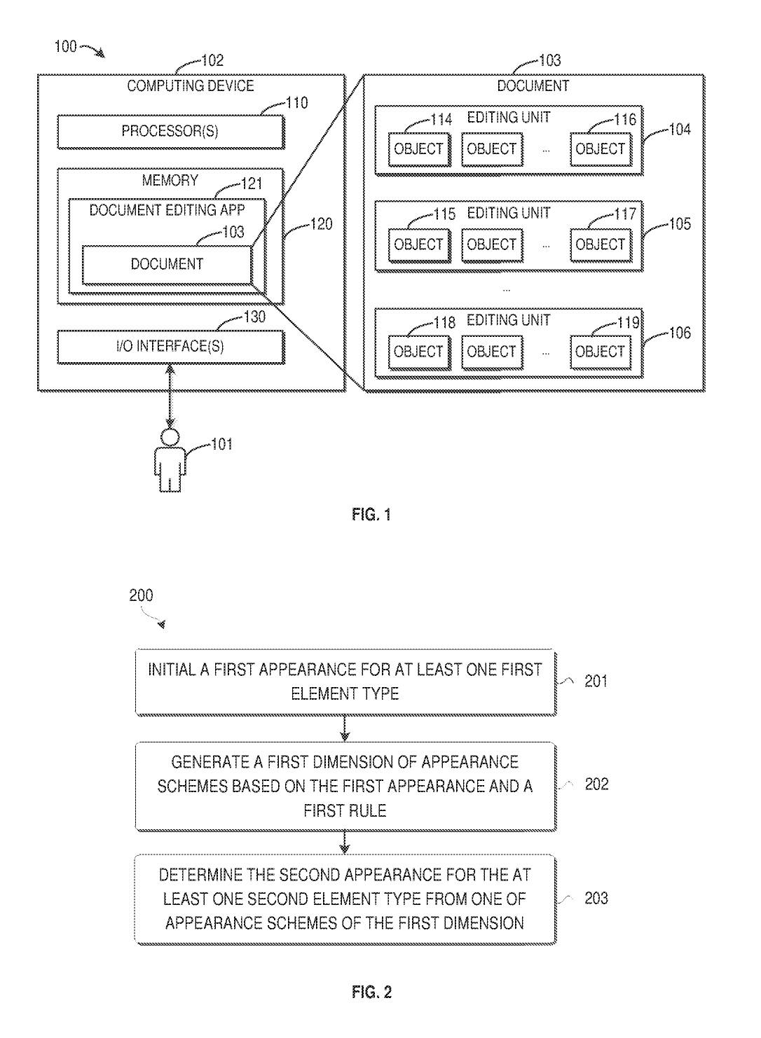

FIG. 1 illustrates a block diagram of an environment 100 where implementations of the subject matter described herein can be implemented. As shown, the environment 100 includes a user 101 and a computing device 102.

The computing device 102 may be a desktop computer, a laptop computer, a tablet, a smart phone, or any other types of computing device. The computing device 102 may include one or more processors 110, a memory 120, and one or more I/O interfaces 130. The memory 120 may store various modules, applications, programs, or other data. Further, the memory 120 may include instructions that, when executed by the processor(s) 110, cause the processor(s) 110 to perform operations described herein for the computing device 102. In the computing device 102, the I/O interface(s) 130 may support one or more of various different input devices and output devices that enable the user 101 to interact with the computing device 102. For example, the input device(s) may include a user device such as keyboard, keypad, touch pad, trackball, and the like. The output device(s) may include a display, for example.

The computing device 102 may have additional features and/or functionality. For example, the computing device 102 may also include additional data storage devices (removable and/or non-removable), such as magnetic disks, optical disks, or tape. Such additional storage may include removable storage and/or non-removable storage. Computer-readable media may include at least two types of computer-readable media, namely computer storage media and communication media. Computer storage media may include volatile and non-volatile, removable, and non-removable media implemented in any method or technology for storage of information, such as computer readable instructions, data structures, program modules, program data, or other data. The system memory, the removable storage and the non-removable storage are all examples of computer storage media. Computer storage media includes, but is not limited to, RAM, ROM, EEPROM, flash memory or other memory technology, CD-ROM, digital versatile disks (DVD), or other optical storage, magnetic cassettes, magnetic tape, magnetic disk storage or other magnetic storage devices, or any other medium that can be used to store the desired information and which can be accessed by the computing device 102. Any such computer storage media may be part of the computing device 102. Moreover, the computer-readable media may include computer-executable instructions that, when executed by the processor(s), perform various functions and/or operations described herein. In contrast, communication media may embody computer-readable instructions, data structures, program modules, or other data in a modulated data signal, such as a carrier wave, or other mechanism. As defined herein, computer storage media does not include communication media.

The memory 120 may store a document editing application 121 text processing application or slide presentation application. The document editing application 121 may operate on a document 103. For example, the documents 103 may be a presentation document or a text document. The document 103 may include one or more editing units. As used herein, the term “editing units” refers to basic units composing the document 103. Examples of the editing units include, but not limited to, slides in a presentation document or pages in a text document, such as editing units 104, 105 and 106 as shown in FIG. 1. Each of the editing units may include one or more elements (for example, shapes, lines, paragraphs, or the like). For example, the editing unit 104 is shown to include elements 114 and 116, the editing unit 104 is shown to include elements 115 and 117 and the editing unit 106 is shown to include elements 118 and 119. In the following discussions, only for the purpose of illustration, some implementations will be described where the document 103 is a presentation document and the editing units 104, 105 and 106 are slides within the presentation document.

FIG. 2 illustrates a flowchart of a method 200 of determining appearances for elements displayed on a user interface in accordance with an example implementation. Each of the elements may have an element type or be assigned with an element type. In one implementation, the method 100 can be executed by the computing device 102, or more particularly, by the processor(s) 110 shown in FIG. 1. The user interface can be the I/O interface 130 shown in FIG. 1 which is used to display the document including various elements to the user. The user is allowed to input or manipulate the elements, or determine the appearance for the elements via the user interface.

In step 201, a first appearance for at least one first element type is initialized. The first appearance specifies a first set of values of attributes for the at least one first element type. Each element in a document can be classified as one of various element types such as shape, line, background, text string, title and the like. Further, each element may be displayed based on its attributes such as color, font, size, relative distance to another element (for example, a margin size of a text area within a page), and so on, all of which determine the appearance of the particular element. The initialization done in step 201 may be carried out by the user manually via the user interface, or by the document editing application 121 in accordance with some preset rules, or even by a random assignment of attribute values.

In step 202, a first dimension of appearance schemes is generated based on the first appearance and a first rule. Each appearance scheme of the first dimension includes at least one second element type associated with a second appearance. The second appearance specifies a second set of values of attributes for the at least one second element type. Therefore, a number of appearance schemes can be further visualized by the user interface showing how the attributes (such as color, font, size, margin, position, etc.) of the elements change the visual effect. In addition, each appearance scheme of the first dimension may include elements of the second element types only, or elements of both the first element types and the second element types.

In step 203, a second appearance for the at least one second element type is determined from one of appearance schemes of the first dimension. As a result, efficiency of operating the at least one second element type via the user interface can be improved.

In one situation, it can be assumed that the document includes only two elements, one of which being a first element type and the other being a second element type. The appearance for the first element type may be initialized in step 201 at the very beginning. For example, the user may set a font size for a title, and thus the font size is the first appearance and the title is the first element type. Alternatively, the user interface may be able to set a font size for the first element type based on a predefined logic. For example, the user interface may display the first element (for example, title) shown in a default size, or in a size captured (or extracted) from other documents (so as to mimic the appearance of other document).

The initialization of the appearance for the first element type is followed by generating a number of proposed schemes in step 202 for the user' selection. In some implementations, the proposed schemes may be generated based on the appearance (font size) for the first element type (title), which can be used to propose the multiple schemes in accordance with a rule, so that the second element (background or page) may have an appearance (distance from the title to the upper border of the background or page) that is related to the first element. The rule is usually empirical based and thus the generated proposed schemes for displaying the two elements appear harmonious to most of human beings.

In one example, the user is able to determine, in step 203, which appearance for the second element is preferred. In other words, how far the title is located from the upper border of the background or page (that is, the upper margin) can be determined. Alternatively, one of the schemes may be determined automatically based on a predefined rule. The appearance (the distance from the tile to the upper border of the background or page) of the second element (the background or page) can even be determined randomly out of the proposed schemes. Although the method 200 is primarily described with reference to the determination of the upper margin for the second element(s), other attributes for the second element type(s) can be determined in a similar way, for example, based on predefined rules or randomly, thereby determining the appearance of the second element.

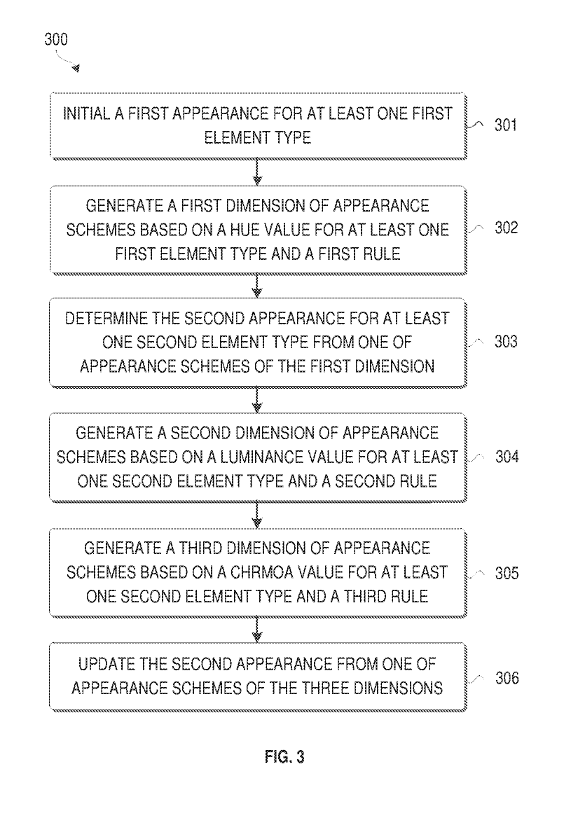

FIG. 3 illustrates a flowchart of a method 300 of determining appearances for elements displayed on a user interface in accordance with an example implementation. Steps 301, 302 and 303 of the method 300 may correspond to steps 201, 202 and 203 of the method 200 as described with reference to FIG. 2, respectively, and thus will not be repeated herein. In this example, determination of colors as appearances for different element types is to be discussed.

This example aims for recoloring different elements in a document shown by a user interface. Sometimes the users may need to create or find color themes to be applied to target documents. As used herein, a color theme refers to a set of colors allocated to different elements in a single or a number of documents so as to present the documents more vividly or enhance the readability. Such elements may refer to components that can be displayed via the user interface such as a background of the document, some text strings arranged in the documents, some shapes having particular meanings for the user interaction, and the like.

Color themes are often related to specific layouts and packaged as document templates. Such templates, though, are limited in number and quality and thus cannot provide a large enough pool for a user to choose from. Users also have the ability to create their own color themes by specifying the colors of document backgrounds, text, and accents (such as titles, subtitles and other headlines) directly, for example, by selecting colors in the RGB (Red-Green-Blue) color space or the HSL (Hue-Saturation-Lightness) color space, or the HCL (Hue-Chroma-Luminance).

An RGB color space can be understood by thinking of it as “all possible colors” that can be made from three colourants for red, green and blue, each color being represented by a value. RGB is not linked to perceptual qualities. An HSL or HCL color space is a color space based on measurements of human color perception and it is described by a hue, a chroma and a luminance (or lightness). HSL is linked to perceptual qualities but in a non-uniform way, while HCL is a perceptually-uniform color model. Hue is the degree to which a stimulus can be described as similar to or different from stimuli that are described as red, orange, yellow, green, blue, and violet. Chroma is the colorfulness relative to the brightness of a similarly illuminated area that appears to be white or highly transmitting. Lightness or luminance means brightness of an area judged relative to the brightness of a similarly illuminated area that appears to be white or highly transmitting. Each color within the HCL color space is defined by a triplet of values. Within the HCL space, each of those dimensions (hue, chroma, and luminance) can be explicitly controlled.

Setting the appearance such as the color of an element is particularly difficult when using the RGB color space, since changing the amount of red, green, or blue in a color changes both the hue and lightness. The HCL color space attempts to solve this problem by providing a direct representation of the color hue and lightness. However, in this model, not all hues have the same inherent lightness, and thus hue and lightness cannot be controlled independently.

The HCL color space provides a way to adjust colors in a hue spectrum. The hue spectrum defines a spectrum of hues changing with phase. The hue spectrum can be a full spectrum representing maximum entries of hues, and it can also be a part of the full spectrum representing a number of entries of hues. In one implementation, the hue spectrum can be represented, for example, as a hue wheel or color wheel made up of a 360-degree enclosing band. The hue wheel presents various colors in a wheel-shape area, and a particular color can correspond to a specific point within the wheel. For example, a selected hue may be described by a degree in relation to the hue wheel. Therefore, color schemes can be regarded as logical combinations of colors on the color wheel.

In step 304, a second dimension of appearance schemes is generated based on the luminance value of the second appearance and a second rule for assigning luminance values here. Each of appearance schemes of the second dimension is associated with a luminance value for the at least two second element types. In step 305, a third dimension of appearance schemes is generated based on the chroma value of the second appearance and a third rule for assigning chroma values. Each appearance scheme of the third dimension is associated with a chroma value for the at least two second element types. In step 306, the second appearance for the at least one second element type is updated from one of appearance schemes of the first dimension, the second dimension and the third dimension.

Because the appearance for the second element type(s) is determined in step 303, an additional dimension or second dimension of proposed schemes can be generated in step 304 in terms of luminance based on the determined appearance for the second element type(s) and/or the first element type(s). This additional dimension of schemes provides a number of possible appearances, each of which gives a distinct contrast presentation.

Similarly, in step 305, a further dimension or third dimension of proposed schemes can be generated in terms of chroma based on the determined appearance for the second element type(s) and/or the first element type(s). The three dimensions of schemes altogether provide a great variation of proposed color schemes displayed separately in three aspects—hue, luminance and chroma.

In one implementation, the step 306 may be carried out when being invoked by the user, for example, by selecting one from the schemes of the dimensions as the updated appearance for the second element type(s). In some situations, such an update may result in a change of the hue value for the first element type(s). Accordingly, steps 301 to 305 may be carried out to propose refreshed sets of color schemes ready for selection.

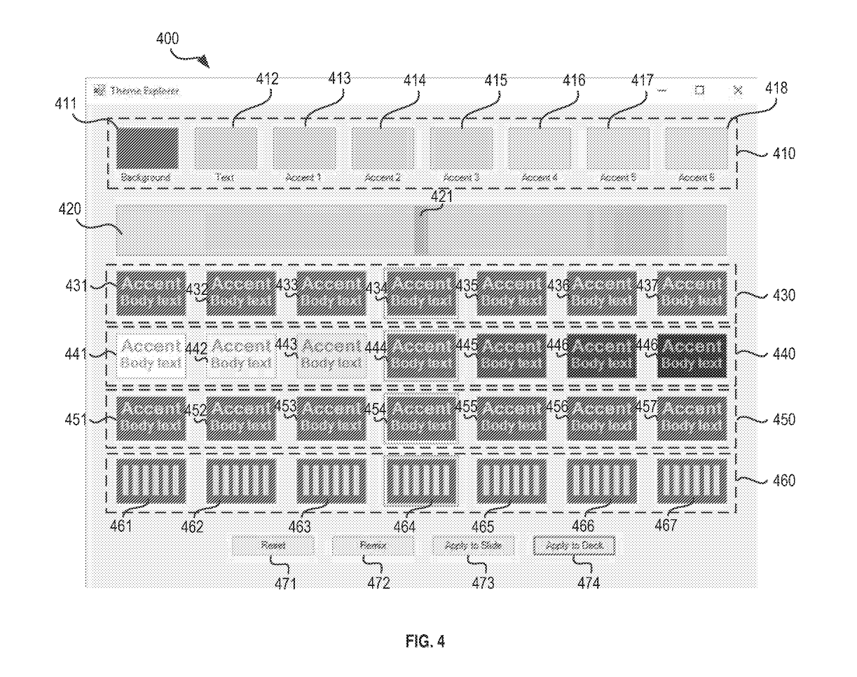

FIG. 4 illustrates an example user interface 400 for determining appearances for various elements used in a document. The document can be of any format and displayable by a typical display device. In one example, the document contains at least one element having the corresponding element type such as title, paragraph text string, page (background), shape, or a series of characters, or a displayable area, as explained above. Each of these element types can be assigned with at least one attribute such as size, color, font, position, etc., and all the attributes for one element type make up an appearance for the element type.

In this implementation, appearances for the element types to be explained are specific to colors in HCL color space as an example. When there are a number of element types within a single document, only different element types are given their respective colors can be a user possible to distinguish the difference between the element types. Further, only if the differences among the colors are large enough the information can be recognizable by displaying. For example, for a document, text messages need to have a color different from a background so that the text messages are recognizable by human eyes.

In a document that can be displayed on a user interface, a color configuration for the different element types can be regarded as a color scheme. In one example, such a color scheme may be formed from a set of colors for background colors, text colors, and accent colors. The background colors are intended to be the colors of the background of the document. The text colors are intended for the regular text of the document, such as the texts for the passages or paragraphs containing a lot of words. The accent colors are intended for the emphasis or categorization of text strings or for the fill and line colors of decorative or illustrative element types, for example, the lines of bar charts or shapes of other graphics such as diagrams.

In some situations, users are allowed to set the appearances especially colors for the element types within a document. However, it is difficult for most users to choose a satisfying color combination for various element types in a short period of time. An example illustrated by FIG. 4 gives a possible solution for providing users with a number of schemes based on different rules, showing altogether the previewed colors of the background, the text and the accent in different schemes. Only for illustration, an example implementation of the subject matter described herein will now be discussed with reference to an application 121 for generating and processing presentation documents including slides

An example user interface 400 for visualizing a color model and exploring different color themes is shown in FIG. 4. The user interface 400 as shown is a standalone window to be run in a window-based operating system. However, the user interface 400 can be of other form or can be integrated in other programs, and thus the subject matter described herein is not intended to make any limitation to the shape, position and configuration of the user interface.

A top portion 410 of the user interface 400 includes a number of colored boxes representing the colors of the current scheme. From left to right, the top portion 410 contains a background color box 411, a text color box 412, and six accent color boxes 413-418. However, it is to be understood that the form, shape, size or arrangement of these boxes is not to be limited. There can be more or less number of boxes, for example, two background color boxes or only one accent color box, depending on actual requirements.

A hue bar 420 is shown below the top portion 410 of the user interface 400 for controlling the hue of a primary accent color which is displayed in the first accent color box 413. The primary accent or the first accent may be regarded as a specific example of the first element type or one of the first element types illustrated by reference to FIG. 2 or 3. The hue bar 420 shows a full spectrum of hues along a horizontal axis. Although hues are quantized into 41 discrete values and displayed consecutively in this implementation, there are many other ways to present more or less hues to be displayed or chosen by a user. The hue of the primary accent or the first accent can be seen as a first dimension which can be firstly decided either manually or automatically. Chroma values as well as luminance values can be preset or determined by other dimensions to be explained later. A current selected hue value, in the implementation shown in FIG. 4, is displayed within a darkened rectangular 421 placed in the middle of the hue bar 420. The darkened area or rectangular is merely used for allowing the user to know which hue value is now adopted, and thus other forms of indicators can also be used for informing users the current hue being selected.

After the hue value for the primary accent is selected, hue values for the background and text are to be determined based on some empirical rules. The background and text can be regarded as a specific example of the second element types illustrated by reference to FIG. 2 or 3. The hues of the background and the text can be seen as a second dimension. In this implementation, hue values for the background and for the text can be obtained on a 360-degree hue wheel according to well-established “harmonious” hue relationships from color theory, as discussed above. The luminance value and the chroma value for the primary accent can be predetermined or can be determined based on the selected hue value of the primary accent, so that the color rendition of the primary accent is done.

Examples of typical rules for determining the hue values for the background and for the text include, but are not limited to, analogous rule, complementary rule, triadic rule, and T-shape rule. The analogous rule specifies that a sequence of hues that are close together in terms of degree difference on the hue wheel. Specifically, the hues resulted from the analogous rule are separated by fixed intervals on the hue wheel. The complementary rule specifies that a pair of hues are opposite on the hue wheel, or separated by 180 degrees. The triadic rule specifies that three hues or more than three hues form an equilateral triangle on the hue wheel, each separated by 120 degrees. The T-shaped rule specifies that three or more hues form a correlation in which two hues are complementary (separated by 180 degrees) and the other hue is perpendicular to a connection line between the complementary hues.

Based on the hue value for the first accent and some or all of above rules or a combination thereof, a first set of schemes or hue schemes 430 are displayed. The first set of schemes or hue schemes 430 contains a number of hue boxes 431-437, each of which displays the accent, the text and the background by rendering their proposed colors. The luminance values and the chroma values for the hue boxes 431-337 may be the same or similar. It is to be understood that the first set of schemes 430 can be obtained with more or less proposed boxes, although seven hue boxes 431-437 are illustrated in FIG. 4 for the particular first set of schemes 430. In addition, the form, shape, size or arrangement of the hue box is not to be limited.

The scheme for a first hue box 431 can be obtained by the analogous rule, for example. For instance, given that the hue for the first accent is 0 degree on the hue wheel, the hue for the background can be +330 degree and the hue for the text can be +300 degree, with a 30-degree interval. The scheme for a second hue box 432 can be obtained by the T-shaped rule. For example, given that the hue for the first accent is 0 degree on the hue wheel, the hue for the background can be +270 degree and the hue for the text can be +90 degree. The scheme for a third hue box 433 can be obtained by the triadic rule. For example, given that the hue for the first accent is 0 degree on the hue wheel, the hue for the background can be +240 degree and the hue for the text can be +120 degree. The scheme for a fourth hue box 434 can be obtained by the complementary rule. For example, given that the hue for the first accent is 0 degree on the hue wheel, the hue for the background can be +180 degree and the hue for the text can be +180 degree. The scheme for a fifth hue box 435 can be obtained by the triadic rule. For example, given that the hue for the first accent is 0 degree on the hue wheel, the hue for the background can be +120 degree and the hue for the text can be +240 degree, with a direction opposite to the scheme for a third hue box 433. The scheme for a sixth hue box 436 can be obtained by the T-shaped rule. For example, given that the hue for the first accent is 0 degree on the hue wheel, the hue for the background can be +90 degree and the hue for the text can be +270 degree, with a direction opposite to the scheme for a second hue box 432. The scheme for a seventh hue box 437 can be obtained by the analogous rule. For example, given that the hue for the first accent is 0 degree on the hue wheel, the hue for the background can be +30 degree and the hue for the text can be +60 degree, with a direction opposite to the scheme for a first hue box 431. It is to be understood that the values described in the above examples are only for illustration, without suggesting any limitations as to the scope of the subject matter described herein.

Based on the colors associated with the element types of one of the first set of schemes 330 and some or all of luminance rules (which are to be discussed below), a second set of schemes or luminance schemes 440 are displayed. The second set of schemes 340 contains a number of luminance boxes 441-447, each displaying the accent, the text and the background by rendering their proposed colors. The hue values for the different luminance boxes 441-447 may be the same or similar, and in one example can be identical to one of the first set of schemes 430. The chroma values for the luminance boxes 441-447 may be the same or similar as well. Meanwhile, the luminance values for the different luminance boxes 441-447 vary from left to right. It is to be understood that the second set of schemes 440 can be obtained with more or less proposed boxes, although seven luminance boxes 441-447 are illustrated in FIG. 4 for the particular second set of schemes 440. In addition, the form, shape, size and arrangement of the luminance box are not to be limited to the examples as described above.

The luminance values of the background and the text or additionally the accents can be seen as a third dimension. The third dimension controls the contrast between the background and a foreground by varying their luminance values. The foreground may contain the text and/or the accents. In one implementation, the luminance values can be represented in a range from 0 to 100, with the lowest value or value “0” corresponding to the darkest luminance and the highest value or value “100” corresponding to the lightest luminance. The luminance values applied to different element types within one of the luminance boxes 441-447 can be controlled by a certain luminance rule. For example, the difference on luminance between the foreground and the background can be controlled to be above a threshold so that the contrast between the text and the background appears appropriately large enough to human eyes.

Some of the luminance rules can be preset in such a way that the foreground and the background have a suitable luminance ratio such as 65/100, 60/95, 55/90, 85/40, 80/30, 75/20, 70/10 and the like, for example. In other words, the difference between the luminance values may be at least 35 in this example. As shown in FIG. 4, the luminance box 441 has a lightest background, and the luminance for the background is gradually darkened from left to right. On the other hand, the luminance box 447 has a lightest foreground, and the luminance for the foreground gradually decreases from right to left. The foreground in this example contains both an accent element type and a text element type, which may have the same or similar luminance values. In some other examples, the accent element type may have a different luminance value from the text element type, and the luminance values of these element types may be changed in accordance with some other predetermined rules like those explained above.

Based on the colors associated with the element types of one of the first set of schemes 430 and some or all of chroma rules (which are to be discussed below), a third set of schemes or chroma schemes 350 are displayed. The third set of schemes 450 contains a number of chroma boxes 351-357, each displaying the accent, the text and the background by rendering their proposed colors. The hue values for the different chroma boxes 451-457 may be the same or similar, and in one example can be identical to one of the first set of schemes 430. The luminance values for the chroma boxes 451-457 may be the same or similar as well. Meanwhile, the chroma values for the different chroma boxes 451-457 vary from left to right. It is to be understood that the third set of schemes 450 can be obtained with more or less proposed boxes, although seven chroma boxes 451-457 are illustrated in FIG. 4 for the particular third set of schemes 450. In addition, the form, shape, size or arrangement of the chroma box is not to be limited.

The chroma values of the background and the text or the accents can be seen as a fourth dimension. The fourth dimension controls the colorfulness levels of the background and a foreground by varying their chroma values. The foreground may contain the text and/or the accents. In one implementation, the chroma values can be represented in a range from 0 to a certain preset value (for example, 128·\sqrt{2} or a smaller value), with the lowest value or value “0” corresponding to the lowest colorfulness and the highest value or value “128” corresponding to the highest colorfulness. The chroma values applied to different element types within one of the chroma boxes 451-457 can be intentionally controlled by a certain chroma rule. For example, the difference on chroma between the foreground and the background can be controlled to be above a threshold so that the colorfulness between the text and the background appears appropriately to human eyes.

Some of the chroma rules can be preset in such a way that the foreground and the background have a suitable chroma ratio such as 20/0, 30/7, 40/14, 50/21, 60/28, 70/35, 80/42 and the like. In other words, the difference between the luminance values may be at least 20 in this example. As shown in FIG. 4, the chroma box 451 has a least colorful background, and the chroma for the background is gradually enhanced from left to right. Additionally, although the chroma box 451 has a more colorful foreground than its background, the chroma for the foreground is also gradually enhanced from right to left to ensure the difference on chroma between the foreground and the background is above a threshold. The foreground in this example contains both an accent element type and a text element type, which may have identical or similar chroma values. In another example, the accent element type may always have a more colorful chroma value than that of the text element type. For example, a ratio of the chroma value for the text to the chroma value for the accent can be 0.75.

In the implementation illustrated in FIG. 4, each of the second, third and fourth dimensions provides 7 schemes or selections for displaying on the user interface 400. As discussed above, the first set of schemes 430, the second set of schemes 440, and the third set of schemes 450 are determined in response to the decision of the color or hue of the primary accent, and based on some empirical rules which assist in the generation of a number of schemes that appears harmonious.

For the implementation shown in FIG. 4, there are 21 boxes showing the previewed effects for the appearances of different element type (the primary accent, the text and the background here) varying in hue, luminance and chroma. A default or preselected appearance may be chosen either by the application 121 or by the user manually. In FIG. 4, the fourth hue box 434 is surrounded by a rectangular larger box, meaning that the current appearance for the element types is adopted from this particular scheme, and the combined effects for the primary accent, the text and the background can be viewed in the hue box 434 and/or in the corresponding boxes of the top portion 410. In this example, the hue scheme 434, the luminance scheme 444, and the chroma scheme 454 have same appearances, and they are each surrounded by a larger box. Each of the first, second and third set of schemes may has a box showing the current appearance. It is to be understood that the surrounded rectangular boxes are merely used for illustration without suggesting any limitations as to the scope of the subject matter described herein. Other forms of indicators may be used to inform users which box corresponds to the current appearance.

More than one accent may be involved in a document. As shown by the rightmost six boxes in the top portion 410, accents 1-6 (boxes 413-418) are displayed in a row, where the accent 1 refers to the primary accent as discussed above. In case that there are at least two accents, the appearances associated with all of the accents can be seen as a fifth dimension. A number of schemes for the accent combinations can be provided at a fourth set of schemes 460 especially illustrating some recommended combinations of the appearances applied to the accents.

The fifth dimension determines how the set of six accents in this example is generated from the primary accent hue selected in the first dimension. These are a combination of three different inter-accent hue intervals (small, medium, and large) and two directions on the hue wheel (clockwise and counterclockwise). It is possible to use a same hue for all accents but progressively reduce the chroma to achieve a monochromatic saturation-based color harmony.

Based on the appearance for the first accent and some of the rules to be discussed below, the fourth set of schemes 460 are displayed, which contains a number of accent boxes 461-467, each displaying appearances of all the accents by rendering their proposed colors. Each of the accents in one of the accent boxes 461-467 can be previewed by a series of vertical bars as shown in FIG. 4. However, the forms, shapes, sizes and arrangements of the previewed accents are not to be limited herein. It is to be understood that the fourth set of schemes 460 can be obtained with more or less proposed boxes, although seven accent boxes 461-467 are illustrated in FIG. 4 for the particular fourth set of schemes 460. In addition, the form, shape, size or arrangement of the hue box is not to be limited.

In the implementation shown in FIG. 4, the accent box 461 has six vertical bars (including the primary accent) each is offset by +36 degrees (the “clockwise large interval”) on the hue wheel from the primary accent. The accent box 462 has six vertical bars each is offset by +22 degrees (the “clockwise medium interval”) on the hue wheel from the primary accent. The accent box 463 has six vertical bars each is offset by +13 degrees (the “clockwise small interval”) on the hue wheel from the primary accent. The accent box 464 has six vertical bars sharing the same hue values. However, their chroma values are each reduced by 18% from the primary accent to the rightmost accent. The accent box 465 has six vertical bars each is offset by −13 degrees (the “counterclockwise small interval”) on the hue wheel from the primary accent. The accent box 466 has six vertical bars each is offset by −22 degrees (the “counterclockwise medium interval”) on the hue wheel from the primary accent. The accent box 467 has six vertical bars each is offset by −36 degrees (the “counterclockwise large interval”) on the hue wheel from the primary accent. In the above example, the intervals may be designed such that the sixth color of the small and medium interval accent ranges are the same as the fourth color of the medium and large accent ranges respectively.

Altogether, all the five dimensions support a vast amount of distinct schemes. The number of expressible schemes can be varied by varying the number of dimensions or the number of schemes in each dimension. Adequate number of dimensions or schemes in each dimension may be of importance because this allows users easily distinguishing the differences, while providing sufficiently enough selections.

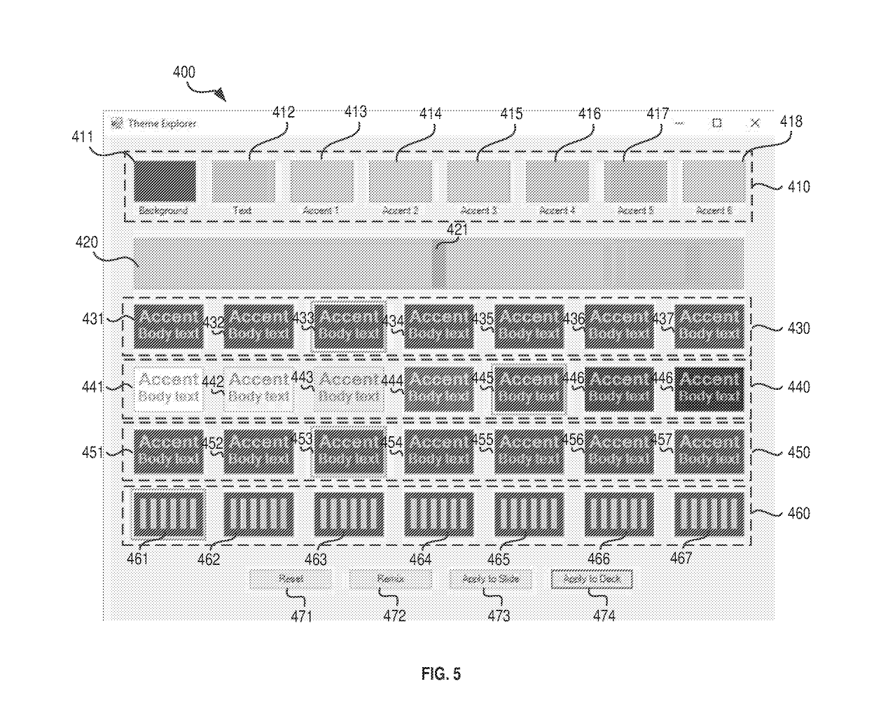

FIG. 5 illustrates an updated user interface 400 after choosing a different scheme other than the current scheme shown in FIG. 4. In other words, FIG. 5 shows the user interface 400 after the updating step is invoked as described by reference to FIG. 2 or FIG. 3. Upon selecting a different scheme in one of the sets of schemes, the generated schemes for other sets of schemes will also be changed accordingly because hue, luminance and chroma values for all the schemes are automatically re-calculated in real time. The users may choose the scheme corresponding to the hue box 433 and the sequences for all sets of schemes are changed accordingly. For example, the luminance box 445 and the chroma box 453 are all displaying the current appearance, each being surrounded by a rectangular larger box.

A consequence of crafting a color model of moderate expressivity is that across a population of users, it is possible for different users to create the same color scheme incidentally, or for one user to create a color scheme that has never been created before. In one implementation, if the user interface 400 supports tracking of all color schemes created, it can provide feedback as to how many times the current color scheme has previously been created. Moreover, adding the ability to rate and tag the current color scheme can provide a social feedback mechanism that assists users in their selection of aesthetic color combinations, and the schemes can thus be ranked by popularity and searched by text descriptions.

Below the dimension options in the example user interface 400 lie four buttons 471-474. The “Reset” button 471 resets all schemes to their default or predefined values. The “Remix” button 472 randomly determines a hue value for the primary accent and generates the values for the rest schemes. The current appearance can also be selected randomly by clicking the “Remix” button 472 schemes for each dimension to help users find random inspiration for a color scheme. The following “Apply to Slide” button 473 and “Apply to Deck” button 474 apply the current color scheme to the active presentation.

In one implementation, these buttons may override existing color assignments in a conventional way: slide backgrounds are given a solid fill in the background color; slide titles are given the primary accent font color; other text shapes are given the text font color; any shape fills are set to the background color; any lines are set to the text color; and any graphical elements with contrasting shape fills are assigned to the full range of accent colors. Existing slide or shape fills that use accent colors can also retain their accent color reference and have the brightness adjusted to create the desired contrast.

In one implementation, upon operating the user interface, the selected schemes can be automatically calculated such that the initial color scheme is the closest match to the colors currently on the slide, no matter whether they come from the existing color theme or are assigned directly (for example, through an RGB color picker). This allows simple, model-based manipulations of the applied color scheme to adjust the presentation contrast to dark text on a white background suitable for printing. Similarly, the colors of a selected image could also be used to calculate the closest matching color model. However, any approach based purely on such constrained color models does not allow for very fine-grained control to tweak presentation contrast such that text has optimum legibility on a given projector. For this purpose, additional color controls can be offered using ad-hoc color modelling in the HCL color space: colors +/−, contrast +/−, and color(fullness) +/−, which are used to further fine tune the selected scheme.

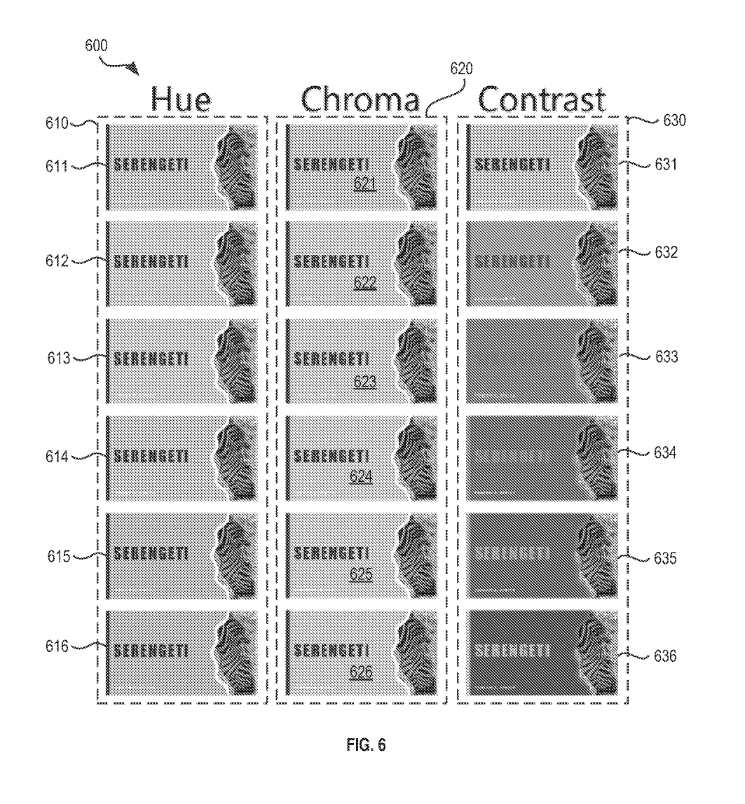

FIG. 6 shows another example user interface 600 for determining appearances for various element types used in a document. In this implementation, the document may refer to presentation slides. When the user invokes a color control, the user interface 600 analyses the structure of the slides in terms of shape types, fills, and overlaps among the element types, to determine which text lies on which background (important for controlling contrast). The user interface 600 also transforms all RGB colors and theme color references into the HCL color space. Based on this analysis, the user interface 600 creates mappings from initial colors to transformed colors and mappings from initial colors to each of their proposed hue, chroma, and luminance targets. The resulting appearances for hue, chroma and contrast (luminance) are displayed in three columns 610, 620, 630 independently to showcase some proposed variations from the initial appearance.

The proposed hue targets 612-616 may be generated from the initial hue value for an initial target 611 by rotating hues around the color wheel without affecting the relative angles between hues. The proposed chroma targets 622-626 may be set based on the initial chroma value for an initial target 621, such that the rotation of hues may not affect the colorfulness of the transformed colors shown in the proposed chroma targets 622-626. Manipulating the chroma control adjusts the level of a maximum chroma threshold initially set to be the maximum chroma in the document. Luminance targets 632-636 may be set with analysis of slide structure by some of rules explained below.

If a text shape has a color fill, the shape fill can be adjusted to be the opposite luminance to the mean luminance of the visible text (light or dark). Otherwise, if the shape overlaps another filled shape (which may provide a background for multiple text shapes), the text luminance can be adjusted to be opposite that of the background shape. Finally, in other situations, the text luminance can be set to contrast with the luminance of the slide background. In this way, text or fills that are initially of the same color may become transformed in opposite directions based on slide structure. If the user reduces the contrast more times than they have increased it (or vice versa), the user interface 600 may flip all luminance targets to their opposite values, as shown by the targets 634-646. This enables a smooth transition from slides in one contrast style (e.g., light on dark) to the other (e.g., dark on light).

The subject matter described herein is based on a structured color model that the user can interactively explore to create aesthetic color schemes, without needing to understand the color theory underlying the model. Some of the advantages of such an approach to color scheme creation may include: (a) the color scheme can be selected more quickly; (b) all combinations of proposed schemes represent valid themes that follow established rules/guidelines for combining colors; (c) users simply need to select (through a simple tap, click, or command) options to explore possible color schemes, allowing them to express their creativity and build their desired color scheme in a simple and constrained way; (d) it is possible for users to select the same set of options that have been selected previously by other users, in ways that support social interactions around color schemes (for example, rating and tagging).

While operations are depicted in a particular order in the above descriptions, this should not be understood as requiring that such operations be performed in the particular order shown or in sequential order, or that all illustrated operations be performed, to achieve desirable results. In certain circumstances, multitasking and parallel processing may be advantageous. Likewise, while several details are contained in the above discussions, these should not be construed as limitations on the scope of the subject matter described herein, but rather as descriptions of features that may be specific to particular implementations. Certain features that are described in the context of separate implementations may also be implemented in combination in a single implementation. On the other hand, various features that are described in the context of a single implementation may also be implemented in multiple implementations separately or in any suitable sub-combination.

The subject matter described herein proposes a method and system for determining appearances for elements displayed on a user interface.

In one aspect, example implementations disclosed herein provide a device including: a processing unit and a memory coupled to the processing unit and storing instructions for execution by the processing unit, the instructions. When executed by the processing unit, the instructions cause the device to: initialize a first appearance for at least one first element type, the first appearance specifying a first set of values of attributes for the at least one first element type, generate a first dimension of appearance schemes based on the first appearance and a first rule, each appearance scheme of the first dimension including at least one second element type associated with a second appearance, the second appearance specifying a second set of values of attributes for the at least one second element type, and determine the second appearance for the at least one second element type from one of appearance schemes of the first dimension, to improve efficiency of operating the at least one second element via the user interface.

In an example implementation, each of the first set of values of attributes and the second set of values of attributes may include a hue value, a luminance value and a chroma value, and the first dimension of appearance schemes is generated based on the hue value for the at least one first element type and the first rule.

In another example implementation, when executed by the processing unit, the instructions may further cause the device to, in each appearance scheme of the first dimension, apply predetermined luminance values and predetermined chroma values to the at least one second element type.

In yet another example implementation, the first rule may specify at least one of the following: the hue value for the at least one second element type is within a predefined range of phase difference in a hue spectrum with regards to the hue value for the at least one first element, the hue spectrum defining a spectrum of hues changing with phase, or the hue value for the at least one second element type is shifted in the hue spectrum from the hue value for the at least one first element type by a predefined phase.

In a further example implementation, when executed by the processing unit, the instructions may further cause the device to generate a second dimension of appearance schemes based on the luminance value for the at least one second element type and a second rule, each appearance scheme of the second dimension including at least one second element type associated with a corresponding luminance value, and update the second appearance for the at least one second element type from one of appearance schemes of the first dimension and the second dimension.

Alternatively or additionally, the at least one second element type may include a plurality of second element types, and the second rule specifies that a difference between the luminance value for one of the second element types is greater than the luminance value for another of the second element types by a predefined threshold.

In still another implementation, when executed by the processing unit, the instructions may further cause the device to generate a third dimension of appearance schemes based on the chroma value for the at least one second element type and a third rule, each appearance scheme of the third dimension including at least one second element type associated with a corresponding chroma value, and update the second appearance for the at least one second element type from one of appearance schemes of the first dimension and the third dimension.

Alternatively or additionally, the at least one second element type may include a plurality of second element types, and the third rule specifies that a difference between the chroma value for one of the second element types is greater than the chroma value for another of the second element types by a predefined threshold.

In a further implementation, the at least one first element may include a plurality of first elements, and when executed by the processing unit, the instructions may further cause the device to apply hue values to all of the first element types, each of the hue values being shifted by a predetermined phase in a hue spectrum from the hue value of the first appearance, the hue spectrum defining a spectrum of hues changing with phase.

In another implementation, the attributes may specify properties of the element types including at least one of colors, positions, spacing, sizes, and fonts of the corresponding elements.

In another aspect, example implementations disclosed herein provide a method of determining appearances for elements displayed on a user interface. Each of the elements has an element type. The method includes: initializing a first appearance for at least one first element type, the first appearance specifying a first set of values of attributes for the at least one first element type, generating a first dimension of appearance schemes based on the first appearance and a first rule, each appearance scheme of the first dimension including at least one second element type associated with a second appearance, the second appearance specifying a second set of values of attributes for the at least one second element type, and determining the second appearance for the at least one second element type from one of appearance schemes of the first dimension, to improve efficiency of operating the at least one second element type via the user interface.

In an example implementation, each of the first set of values of attributes and the second set of values of attributes may include a hue value, a luminance value and a chroma value, and the first dimension of appearance schemes is generated based on the hue value for the at least one first element type and the first rule.

In another example implementation, the first rule may specify at least one of the following: the hue value for the at least one second element type is within a predefined range of phase difference in a hue spectrum with regards to the hue value for the at least one first element, the hue spectrum defining a spectrum of hues changing with phase, or the hue value for the at least one second element type is shifted in the hue spectrum from the hue value for the at least one first element type by a predefined phase.

In another example implementation, the method may further include: generating a second dimension of appearance schemes based on the luminance value for the at least one second element type and a second rule, each appearance scheme of the second dimension including at least one second element type associated with a corresponding luminance value, and updating the second appearance for the at least one second element type from one of appearance schemes of the first dimension and the second dimension.

Alternatively or additionally, the at least one second element type may include a plurality of second element types, and the second rule specifies that a difference between the luminance value for one of the second element types is greater than the luminance value for another of the second element types by a predefined threshold.

In yet another example implementation, the method may further include: generating a third dimension of appearance schemes based on the chroma value for the at least one second element type and a third rule, each appearance scheme of the third dimension including at least one second element type associated with a corresponding chroma value, and updating the second appearance for the at least one second element type from one of appearance schemes of the first dimension and the third dimension.

Alternatively or additionally, the at least one second element type may include a plurality of second element types, and the third rule specifies that a difference between the chroma value for one of the second element types is greater than the chroma value for another of the second element types by a predefined threshold.

In a further example implementation, the at least one first element may include a plurality first element types, and the method may further includes: applying hue values to all of the first element types, each of the hue values being shifted by a predetermined phase in a hue spectrum from the hue value of the first appearance, the hue spectrum defining a spectrum of hues changing with phase.

In another example implementation, the attributes may specify properties of elements including at least one of colors, positions, spacing, sizes, and fonts of the corresponding elements.

In another aspect, example implementations disclosed herein provide a computer program product being tangibly stored on a non-transient machine-readable medium and comprising machine-executable instructions, the instructions, when executed on a device, causing the device to: initialize a first appearance for at least one first element type, the first appearance specifying a first set of values of attributes for the at least one first element type, generate a first dimension of appearance schemes based on the first appearance and a first rule, each appearance scheme of the first dimension including at least one second element type associated with a second appearance, the second appearance specifying a second set of values of attributes for the at least one second element type, and determine the second appearance for the at least one second element type from one of appearance schemes of the first dimension, to improve efficiency of operating the at least one second element type via the user interface.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A device comprising:
a processing unit;
a memory coupled to the processing unit and storing instructions for execution by the processing unit, the instructions, when executed by the processing unit, causing the device to:
initialize a first appearance for at least one first element type, the first appearance specifying a first set of values of attributes for the at least one first element type;
generate a first dimension of appearance schemes based on the first appearance and a first rule, each appearance scheme of the first dimension including at least one second element type associated with a second appearance, the second appearance specifying a second set of values of attributes for the at least one second element type; and
determine the second appearance for the at least one second element type from one of appearance schemes of the first dimension, to improve efficiency of operating the at least one second element via the user interface.

2. The device according to claim 1, wherein each of the first set of values of attributes and the second set of values of attributes includes a hue value, a luminance value and a chroma value, and the first dimension of appearance schemes is generated based on the hue value for the at least one first element type and the first rule.

3. The device according to claim 2, wherein the instructions, when executed by the processing unit, further cause the device to:
in each appearance scheme of the first dimension, apply predetermined luminance values and predetermined chroma values to the at least one second element type.

4. The device according to claim 2, wherein the first rule specifies at least one of the following:
the hue value for the at least one second element type is within a predefined range of phase difference in a hue spectrum with regards to the hue value for the at least one first element, the hue spectrum defining a spectrum of hues changing with phase; or
the hue value for the at least one second element type is shifted in the hue spectrum from the hue value for the at least one first element type by a predefined phase.

5. The device according to claim 2, wherein the instructions, when executed by the processing unit, further cause the device to:
generate a second dimension of appearance schemes based on the luminance value for the at least one second element type and a second rule, each appearance scheme of the second dimension including at least one second element type associated with a corresponding luminance value; and
update the second appearance for the at least one second element type from one of appearance schemes of the first dimension and the second dimension.

6. The device according to claim 5, wherein the at least one second element type includes a plurality of second element types, and the second rule specifies that a difference between the luminance value for one of the second element types is greater than the luminance value for another of the second element types by a predefined threshold.

7. The device according to claim 2, wherein the instructions, when executed by the processing unit, further cause the device to:
generate a third dimension of appearance schemes based on the chroma value for the at least one second element type and a third rule, each appearance scheme of the third dimension including at least one second element type associated with a corresponding chroma value; and
update the second appearance for the at least one second element type from one of appearance schemes of the first dimension and the third dimension.

8. The device according to claim 7, wherein the at least one second element type includes a plurality of second element types, and the third rule specifies that a difference between the chroma value for one of the second element types is greater than the chroma value for another of the second element types by a predefined threshold.

9. The device according to claim 2, wherein the at least one first element type includes a plurality of first element types, and the instructions, when executed by the processing unit, further cause the device to:
apply hue values to all of the first element types, each of the hue values being shifted by a predetermined phase in a hue spectrum from the hue value of the first appearance, the hue spectrum defining a spectrum of hues changing with phase.

10. The device according to claim 1, wherein the attributes specify properties of the element types including at least one of colors, positions, spacing, sizes, and fonts of the corresponding elements.

11. A method of determining appearances for elements displayed on a user interface, each of the elements having an element type, the method comprising:
initializing a first appearance for at least one first element type, the first appearance specifying a first set of values of attributes for the at least one first element type;
generating a first dimension of appearance schemes based on the first appearance and a first rule, each appearance scheme of the first dimension including at least one second element type associated with a second appearance, the second appearance specifying a second set of values of attributes for the at least one second element type; and
determining the second appearance for the at least one second element type from one of appearance schemes of the first dimension, to improve efficiency of operating the at least one second element type via the user interface.

12. The method according to claim 11, wherein each of the first set of values of attributes and the second set of values of attributes includes a hue value, a luminance value and a chroma value, and the first dimension of appearance schemes is generated based on the hue value for the at least one first element type and the first rule.

13. The method according to claim 12, wherein the first rule specifies at least one of the following:
the hue value for the at least one second element type is within a predefined range of phase difference in a hue spectrum with regards to the hue value for the at least one first element, the hue spectrum defining a spectrum of hues changing with phase; or
the hue value for the at least one second element type is shifted in the hue spectrum from the hue value for the at least one first element type by a predefined phase.

14. The method according to claim 12, further comprising:
generating a second dimension of appearance schemes based on the luminance value for the at least one second element type and a second rule, each appearance scheme of the second dimension including at least one second element type associated with a corresponding luminance value; and
updating the second appearance for the at least one second element type from one of appearance schemes of the first dimension and the second dimension.

15. The method according to claim 14, wherein the at least one second element type includes a plurality of second element types, and the second rule specifies that a difference between the luminance value for one of the second element types is greater than the luminance value for another of the second element types by a predefined threshold.

16. The method according to claim 12, further comprising:
generating a third dimension of appearance schemes based on the chroma value for the at least one second element type and a third rule, each appearance scheme of the third dimension including at least one second element type associated with a corresponding chroma value; and
updating the second appearance for the at least one second element type from one of appearance schemes of the first dimension and the third dimension.

17. The method according to claim 16, wherein the at least one second element type includes a plurality of second element types, and the third rule specifies that a difference between the chroma value for one of the second element types is greater than the chroma value for another of the second element types by a predefined threshold.

18. The method according to claim 12, wherein the at least one first element type includes a plurality of first element types, and the method further comprises:
applying hue values to all of the first element types, each of the hue values being shifted by a predetermined phase in a hue spectrum from the hue value of the first appearance, the hue spectrum defining a spectrum of hues changing with phase.

19. The method according to claim 11, wherein the attributes specify properties of the element types including at least one of colors, positions, spacing, sizes, and fonts of the corresponding elements.

20. A computer program product being tangibly stored on a non-transient machine-readable medium and comprising machine-executable instructions, the instructions, when executed on a device, causing the device to:
initialize a first appearance for at least one first element type, the first appearance specifying a first set of values of attributes for the at least one first element type;
generate a first dimension of appearance schemes based on the first appearance and a first rule, each appearance scheme of the first dimension including at least one second element type associated with a second appearance, the second appearance specifying a second set of values of attributes for the at least one second element type; and
determine the second appearance for the at least one second element type from one of appearance schemes of the first dimension, to improve efficiency of operating the at least one second element type via the user interface.
